(19) United States
(12) Patent Application Publication
(10) Pub. No.: US 2006/0115384 A1
(43) Pub. Date: Jun. 1, 2006

(54) Pipette tip surface sorption extraction

(75) Inventor: Robert H. Wohleb, Ferndale, CA (US)

Correspondence Address: CRAIN, CATON & JAMES, FIVE HOUSTON CENTER, 1401 MCKINNEY, 17TH FLOOR, HOUSTON, TX, 77010, US

(73) Assignee: Vici Gig Harbor Group, Inc.

(21) Appl. No.: 11/325,189

(22) Filed: Jan. 4, 2006

Related U.S. Application Data
(63) Continuation-in-part of application No. 10/663,955, filed on Sep. 16, 2003.
(60) Provisional application No. 60/646,930, filed on Jan. 25, 2005.

(51) Int. Cl. B01L 3/00

(52) U.S. Cl. 422/101; 422/102

(57) ABSTRACT

A sorption pipette tip is disclosed for the extraction of a sample, or analyte, from a sample matrix with a method of using the sorption pipette tip to perform the extraction. The pipette tip has a coating of a sorptive material. The orifice of the tip may have different configurations that enhance extraction. A sample is aspirated into a sorption pipette tip and either allowed to sit for a given period of time, or the sample aspirated into and out of the pipette tip repeatedly, until the compounds of interest, the analyte, are extracted from the sample by partitioning into the sorptive coating. After partitioning of the sample into the sorptive material, the sample is expelled from the pipette tip. The tip may be washed by aspirating with water. An elution solvent is then used to extract the analytes from the sorptive coating. The solvent containing the compounds of interest, the analyte, may be collected from the pipette tip for further chemistry.

### CROSS-REFERENCE TO RELATED APPLICATIONS

This application is a continuation-in-part under 37 CFR 1.53(b) to U.S. patent application Ser. No. 10/663,955, “Direct Vial Surface Sorbent Micro Extraction Device and Method,” filed on Sep. 16, 2003 by Robert Wohleb and claims priority to U.S. Patent Application No. 60/646,930 filed Jan. 25, 2005.

### STATEMENT REGARDING FEDERALLY-SPONSORED RESEARCH OR DEVELOPMENT

None.

### BACKGROUND OF THE INVENTION

1. Field of the Invention

This invention relates to the extraction and collection of one or more analytes by a sorptive process. Specifically, this invention relates to a device and method for performing pipette tip surface sorption extraction.

2. Description of the Related Art

A pipette is a measuring instrument consisting of a glass or plastic tube used to measure or transfer precise volumes of a liquid by drawing the liquid up into the tube. A pipette tip is a small pipette attached to a mechanical device which causes fluids to be accurately drawn into and dispensed out of the pipette tip. The mechanical device may be designed to have one tip attached for individual fluid manipulations or a device designed to simultaneously manipulate multiple fluid samples in which case it will have more than one tip attached (standard single or multi-channel pipettor). A variety of names are assigned to devices using pipette tips including pipettor and diluter/dispensor.

A pipette tip is typically conical in shape having a circular orifice for fluid transfer on one end and a larger circular end that connects to the device that pumps the fluids.

It is known in the art to use a sorbent to extract an analyte from a solution. The analyte is later extracted from the sorbent by thermal desorption or by back extracting with a small amount of organic solvent. Sorption materials are usually homogenous, non-porous materials that are above their glass transition point (T_{g}) and in which the analyte can dissolve. The analyte may be removed for analysis by thermal desorption or solvent extraction.

It would be an improvement to the art to have coated pipette tips by which the extraction may be directly performed and the components of interest conveniently manipulated for further chemistry.

### BRIEF SUMMARY OF THE INVENTION

The present invention comprises a device and method for pipette tip surface sorption extraction.

Accordingly, the objects of my invention are to provide, inter alia, a single step surface sorption extraction system that:
minimizes the amount of solvent used;
eliminates the need for sorbent conditioning;
reduces sample loss
Improve tip to tip extraction reproducibility
handles viscous samples;
eliminates clogging;
reduces or eliminates sample cross contamination; and
reduces the need for a vacuum system.

This invention is a sorption pipette tip that can be used for the extraction of an analyte from a sample matrix and a method of using the sorption pipette tip to perform the extraction. In this invention the pipette tip has a coating of a sorption material. The orifice of the tip may have different configurations that enhance extraction.

The sample is aspirated into a sorption pipette tip and either allowed to remain in contact with the sorptive coating for a given period of time to allow for partitioning, or the sample may be aspirated into and out of the pipette repeatedly, until the compounds of interest, the analyte(s) are extracted from the sample by partitioning into the sorptive coating.

After partitioning of the sample into the sorptive material, the sample is expelled from the pipette. The pipette may then be washed by aspirating with water. When desired, which may be at a later time, an eluting solvent is used to extract the analytes from the sorptive coating. The solvent containing the compounds of interest, the analyte(s) may be removed from the pipette for further chemistry.

### BRIEF DESCRIPTION OF THE DRAWINGS

FIG. 1 is a cross-sectional view of a pipette tip with a sorption coating.

FIG. 2 is an end view of a pipette with a sorption coating.

FIG. 3 is an end view of a pipette with multiple sorption coated openings.

FIG. 4 is an end view of a pipette with an irregularly shaped sorption coated opening.

### DESCRIPTION OF THE INVENTION

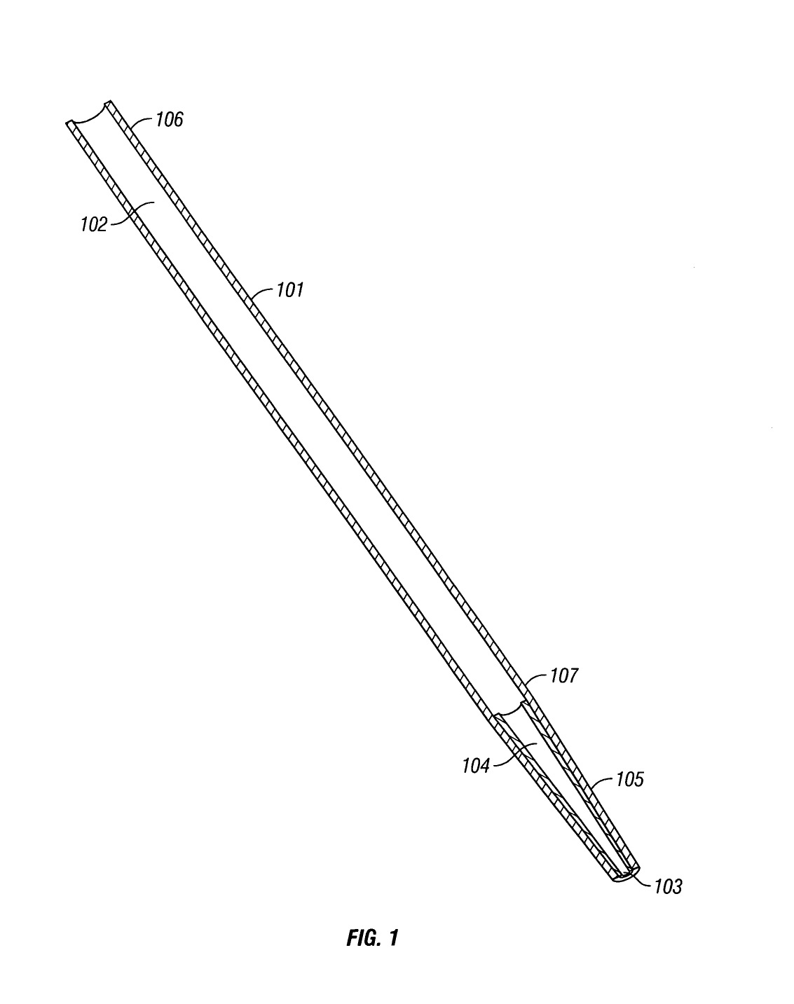

Referring to FIG. 1, the preferred embodiment of the pipette surface sorption extraction device.

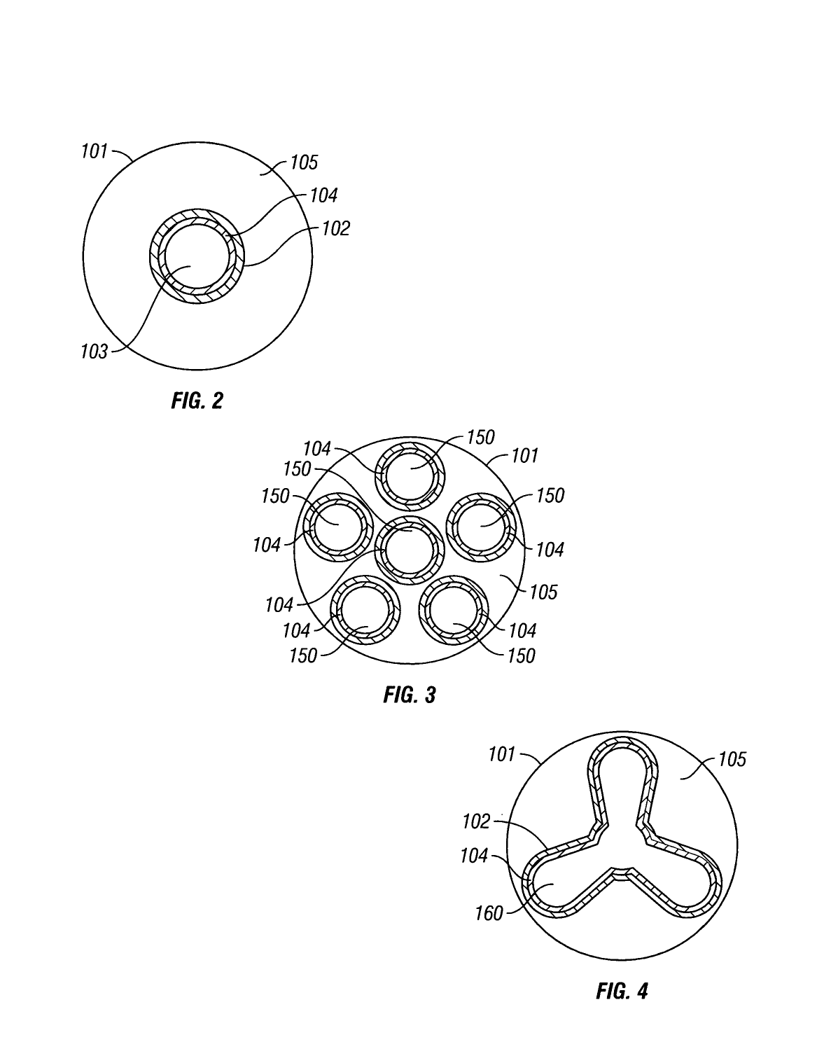

Referring to FIG. 1, sorption pipette 101 is made from a rigid, non-reactive material, such as polypropylene. In the preferred embodiment, pipette 101 has an upper body member 106 with a wall 102 with a pipette tip 105 having a an orifice 103 located at a body first end 107 of pipette 101. In the preferred embodiment the wall 102 and orifice 103 define a cylindrical interior resulting in pipette tip 105 being conic in shape. A sorptive coating 104 is applied to pipette 101. The sorptive coating covers an area less than or equal to the area which may be effectively contacted by the elution solvent to permit release of the analyte upon application. Applying sorbtive coating 104 to an area beyond that which may be effectively contacted by the elution solvent may result in contamination of future samples and in retention of analytes of interest thereby resulting in inaccurate results. Referring to FIG. 2, (pipette tip 105) is coated with sorptive coating 104. FIG. 3 shows a pipette tip of an alternative embodiment, namely one having more than one orifice, specifically six orifices 150 each with a sorptive coating 104. Alternatively, FIG. 4 illustrates an orifice with an irregular shape 160 coated with a sorptive coating 104.

In the preferred embodiment, the sorptive coating 104 is a hydrophobic coating, such as an immobilized polysiloxane, for example polydimethylsiloxane (PDMS), which contains only methyl functional groups. The name “siloxane” is based on the Si—O—Si unit and has found acceptance in scientific nomenclature. Polysiloxanes are polymers with repeating siloxane units. Each repeating siloxane unit contains two functional groups attached (e.g. dimethyl) which may, or may not, be of the same type of functional group. A functional group is an atom or combination of atoms which gives a polymer its distinctive and sorptive qualities. A polysiloxane of 50 repeating units would therefore have 100 methyl groups, whereas a siloxane unit with two different types of groups such as phenylmethyl would have 50 of each “type” of functional group in the polysiloxane. The term ‘functional’ group is linked to the concept of a homologous series. A homologous series is a group of molecules with the same general formula and the same functional group. All molecules in the series therefore have similar physical and chemical properties (albeit with trends e.g., boiling point increases as carbon chain length increases). It is known in the art that immobilized polysiloxanes that contain other types of functional groups may be used as sorbents. These include immobilized polysiloxanes containing phenyl or trifluoropropyl functional groups. Examples of these polysiloxanes include diphenylsiloxane-dimethylsiloxane copolymers and trifluoropropylmethylsiloxanes. For more selective sorption applications the immobilized polysiloxane may contain other types of functional groups including alkyl, alkenyl, alkynyl, aryl, alkylaryl, alkenylaryl, alkynylaryl, haloalkyl or haloaryl. A polysiloxane may contain said types of functional groups in any combination. The selection of a certain type of functional group or groups permits the partitioning of a particular analyte or analytes from the sample. The polysiloxane coating may be a polymer, a copolymer or a combination of polymers.

Alternatively, sorptive coating 104 may be (1) a porous layer, such as a derivatized etched surface, (2) other immobilized polymers that are above their glass transition temperatures such as poly butadiene, (3) an immobilized porous polymer, such as divinylbenzene, ethyleneglycoldimethacrylate, and copolymers of divinylbenzene and ethyleneglycoldimethacrylate, polyethyleneimine, acrylonitrile, n-vinyl-2-pyrollidinone or 4-vinyl-pyridine, (4) a sol-gel or (5) an immobilized adsorbent such as graphitized carbon black. Sorptive coating 104 may be any one of the coatings described or a combination of two or more of the alternative coatings. The selection of the coating or coatings by one skilled in the art is dependent upon the analyte or analytes to be partitioned from sample.

The extraction process comprises aspirating a sample into the surface sorption pipette tip 105 to a volume equal to or less than the claimed tip volume. This is typically accomplished with a syringe or pipettor (not shown). The sample may be allowed to remain in the pipette for a time sufficient for partition equilibration to be obtained. Alternatively, the syringe or pipettor may be used to aspirate the sample in and out of the tip to allow for equilibrated partitioning. The sample is then removed or aspirated from the surface sorption pipette tip 105. When removal of the analyte or analytes is desired, a predetermined amount of an elution solvent (not shown) is measured into surface sorption pipette tip 105 such that the compounds of interest, the analyte(s), are extracted. Typically an amount of solvent slightly greater than that required to cover the sorptive surface is used giving the best back extraction of the compounds of interest, the analyte. The collected analyte may be analyzed by gas chromatography, high performance liquid chromatography or by other analytical instruments. Alternatively, the collected sample may be stored or manipulated for further chemistry.

In some cases the volume of sample is greater than the volume of surface sorption pipette tip 105. Surface sorption pipette tip 105 is then used to repeatedly aspirate the sample in and out with a portion, not exceeding pipette volume, of the solution containing analytes to be extracted. After a sufficient number of repetitive aspirations have allowed partition equilibrium, specifically for for the entire sample to have been in contact with sorbitive coating 104, the sorption pipette tip 105 is emptied. A predetermined amount of an elution solvent (not shown) is aspirated into surface sorption pipette tip 105 as described above.

The foregoing disclosure and description of the invention is illustrative and explanatory thereof. Various changes in the details of the illustrated construction may be made within the scope of the appended claims without departing from the spirit of the invention. The present invention should only be limited by the following claims and their legal equivalents.

What is claimed is:

1. A device for the collection and extraction of at least one analyte within a sample, comprising:
at least one pipette,
said pipette having a body;
said body of said pipette having a first end;
said body of said pipette having an interior
said pipette having a tip, said tip located proximate said first end of said body of said pipette;
said tip of said pipette having an orifice therethrough;
said tip of said pipette having an interior;
said interior of said tip of said pipette being conical;
said interior of said tip of said pipette communicating with said interior of said body of said pipette;
a sorptive coating adhered to said interior of said tip of said pipette;

2. The device of claim 1, wherein said sorptive coating of said pipette tip is made of a polymer.

3. The device of claim 1, further comprising:
said sorptive coating comprising an immobilized polysiloxane polymer having at least one functional group selected from the group consisting of alkyl, alkenyl, alkynyl, aryl, alkylaryl, alkenylaryl, alkynylaryl, haloalkyl or and haloaryl.

4. The device of claim 1, wherein
said sorptive coating is an immobilized polysiloxane polymer having at least two functional groups selected from the group consisting of alkyl, alkenyl, alkynyl, aryl, alkylaryl, alkenylaryl, alkynylaryl, haloalkyl and haloaryl

5. The device of claim 1, wherein said sorptive coating is an immobilized porous polymer.

6. The device of claim 6, wherein said immobilized porous polymer is selected from the group consisting of: divinylbenzene, ethyleneglycoldimethacrylate, polyethyleneimine, acrylonitrile, n-vinyl-2-pyrollidinone, and 4-vinyl-pyridine.

7. The device of claim 1, wherein said sorptive coating is a polymer existing above its glass transition temperature.

8. A method for performing pipette tip surface sorption extraction of analytes from a sample comprising:
adhering a sorptive coating to the interior of the tip of at least one pipette,
each of said at least one pipette having
said pipette having a body;
said body of said pipette having a first end;
said body of said pipette having an interior
said tip located proximate said first end of said body of said pipette;
said tip of said pipette having an orifice therethrough;
said interior of said tip of said pipette being conical;
said interior of said tip of said pipette communicating with said interior of said body of said pipette;
introducing a liquid sample, said liquid sample containing at least one analyte susceptible to sorption by said sorptive coating into a pipette;
contacting said liquid sample to said sorptive coating;
introducing an elution solvent into said pipette; said elution solvent causing said at least one analyte to be separated from said sorptive coating; and
removing said elution solvent and said at least one analyte from said pipette.
